(19) United States
(12) Patent Application Publication
(10) Pub. No.: US 2002/0117766 A1
(43) Pub. Date: Aug. 29, 2002

(54) Method of manufacturing solid state image pick up device having microlenses

(75) Inventor: Sang-sik Kim, Suwon-city (KR)

Correspondence Address: Steven M. Mills, MILLS & ONELLO LLP, Suite 605, Eleven Beacon Street, Boston, MA, 02108, US

(73) Assignee: Samsung Electronics Co., Ltd.

(21) Appl. No.: 10/044,497

(22) Filed: Jan. 10, 2002

(30) Foreign Application Priority Data
Feb. 28, 2001 (KR) 01-10361

(51) Int. Cl. B29D 11/00

(52) U.S. Cl. 264/1.38

(57) ABSTRACT

A method of manufacturing a solid state image pick up device, which is capable of increasing the hardness of a microlens is provided. A plurality of photosensing device arrays are formed on a semiconductor substrate. Next, a plurality of microlenses are formed on the semiconductor substrate on which the photosensing device arrays are formed. Next, the surfaces of the microlenses are hardened by irradiating light into the microlenses.

### BACKGROUND OF THE INVENTION

1. Field of the Invention

The present invention relates to a method of manufacturing a solid state image pick up device having microlenses, and more particularly, to a method of manufacturing a solid state image pick up device which is capable of improving the hardness of microlenses.

2. Description of the Related Art

In general, a solid state image pick up device is used in various fields such as livelihood of the people, industries, broadcasting, and munitions and in devices such as cameras, camcorders, multimedia, and monitoring cameras. As the size of products becomes smaller and the number of pixels increases, demand on an on-chip solid state image pick up device, which includes microlenses, has been recently increased. Microlenses improve the sensitivity of the solid state image pick up device. The performance of the solid state image pick up device is determined according to sensitivity and yield.

Microlenses are convex and are generally formed of an organic material, for example, a photoresist material. In order to make microlenses convex, a predetermined amount of thermal energy is supplied to a material for forming microlenses, and then, the material for forming microlenses is flowed by the supplied thermal energy. As a result, the surfaces of the microlenses have curvature and are hardened.

However, since conventional microlenses are formed of organic material such as photoresist, their transmissivity varies when thermal energy having high temperature is supplied. Accordingly, in order to prevent variation of transmissivity of the material for forming microlenses, processes of providing curvature proceed in a temperature range where the transmissivity of the photoresist does not vary, for example, at a temperature of 200 ° C. or less. When a hardening process proceeds at the above-mentioned low temperature, the pencil hardness of the surfaces of the microlenses, that is, the photoresist, is less than 2. Accordingly, the microlenses are easily broken during a subsequent assembling process or are studded with silicon powder during a process of sawing a die. Therefore, black spot inferiority can easily occur in the microlenses.

When microlenses are damaged or black spot inferiority occurs, the sensitivity of the solid state image pick up device deteriorates.

### SUMMARY OF THE INVENTION

To solve the above problems, it is an object of the present invention to provide a method of manufacturing a solid state image pick up device, which is capable of improving the sensitivity of the solid state image pick up device.

It is another object of the present invention to provide a method of manufacturing a solid state image pick up device, which is capable of improving the hardness of microlenses.

Accordingly, to achieve the first object, there is provided a method of manufacturing a solid state image pick up device having microlenses. In the method, a plurality of photosensing device arrays are formed on a semiconductor substrate. A plurality of microlenses are formed on the semiconductor substrate on which the photosensing device arrays are formed. The surfaces of the microlenses are hardened by irradiating light into the microlenses.

It is preferable that in step of irradiating light into the microlenses, light is irradiated into the microlenses until the pencil hardness of the microlenses reaches 7-10, the light is deep ultraviolet (DUV) rays, and, in the step of irradiating light into the microlenses, DUV rays having a bandwidth between 200 and 400 nm are irradiated into the microlenses so that an optical energy of between 600 and 1,000 mJ/cm² is supplied to the microlenses.

It is also preferable that the step of forming a plurality of photosensing device arrays on the semiconductor substrate includes the steps of providing a semiconductor substrate, in which a plurality of light receiving regions and a plurality of charge transmitting regions are defined, forming optical diodes in the respective light receiving regions, forming charge transmission electrodes in the respective charge transmitting regions, forming light shielding films so that the light receiving regions are exposed, isolating the charge transmitting electrodes and the light shielding films from each other by an insulating film so that the charge transmission electrodes are insulated from the light shielding films, forming pads on predetermined portions of the insulating film, and forming first and second planarizing films in the resultant surface of the semiconductor substrate on which the pads are formed in order.

In one embodiment, color filters are formed between the first and second planarizing films so as to correspond to the light receiving regions, and the first and second planarizing films are formed of a transparent organic material.

It is also preferable that the method further include the step of irradiating UV rays between step of forming the lens pattern and step of supplying thermal energy to the lens pattern, in order to improve the transmissivity of the lens pattern, and the energy of the irradiated UV rays is between 500 and 2,000 mJ/cm². Also, the step of forming the plurality of microlenses includes the steps of forming a material for forming microlenses on the resultant surface of the semiconductor substrate, forming a lens pattern by exposing and developing a predetermined portion of the material for forming the microlenses, and forming microlenses by supplying thermal energy so that the surface of the lens pattern has a radius of curvature. The microlenses are formed so as to correspond to the respective light receiving regions, and the material for forming the microlenses is a transparent organic material.

To achieve the second object, there is provided a method of manufacturing a solid state image pick up device having microlenses. In the method, a plurality of photosensing device arrays are formed on a semiconductor substrate. A plurality of microlenses are formed on the semiconductor substrate on which the photosensing device arrays are formed. The surfaces of the microlenses are hardened by irradiating DUV rays into the microlenses. The DUV rays are irradiated into the microlenses until the pencil hardness of the microlenses reaches 7-10.

It is preferable that in step of irradiating the DUV rays into the microlenses, DUV rays having a bandwidth between 200 and 400 nm are irradiated into the microlenses so that an optical energy of between 600 and 1,000 mJ/cm² is supplied to the microlenses.

It is also preferable that the step of forming the photosensing device arrays include the steps of providing a semiconductor substrate, in which a plurality of light receiving redundant regions and a plurality of charge transmitting regions are defined, forming optical diodes in the respective light receiving regions, forming charge transmission electrodes in the respective charge transmitting regions, forming light shielding films so that the light receiving regions are exposed, isolating the charge transmitting electrodes and the light shielding films from each other by an insulating film so that the charge transmission electrodes are insulated from the light shielding films, forming pads on predetermined portions of the insulating film, and forming first and second planarizing films in the resultant surface of the semiconductor substrate on which the pads are formed in order.

It is also preferable that the method further include the step of forming color filters between the first and second planarizing films so as to correspond to the light receiving regions, and that the planarizing films be formed of a transparent organic material.

It is also preferable that the step of forming the microlens array include the steps of forming a material for forming microlenses on the resultant surface of the semiconductor substrate, forming a lens pattern by exposing and developing a predetermined portion of the material for forming the microlenses, and forming microlenses by supplying thermal energy so that the surface of the lens pattern has a radius of curvature. The microlenses are formed so as to correspond to the respective light receiving regions, and the material for forming the microlenses is a transparent organic material.

### BRIEF DESCRIPTION OF THE DRAWING(S)

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1 through 3 are sectional views illustrating processes of a method of manufacturing a solid state image pick up device according to the present invention.

### DESCRIPTION OF THE PREFERRED EMBODIMENT(S)

The present invention now will be described more fully with reference to the accompanying drawings, in which preferred embodiments of the invention are shown. In the drawings, the thicknesses of layers and regions are exaggerated for clarity. It will also be understood that when a layer is referred to as being “on” another layer or substrate, it can be directly on the other layer or substrate, or intervening layers may also be present.

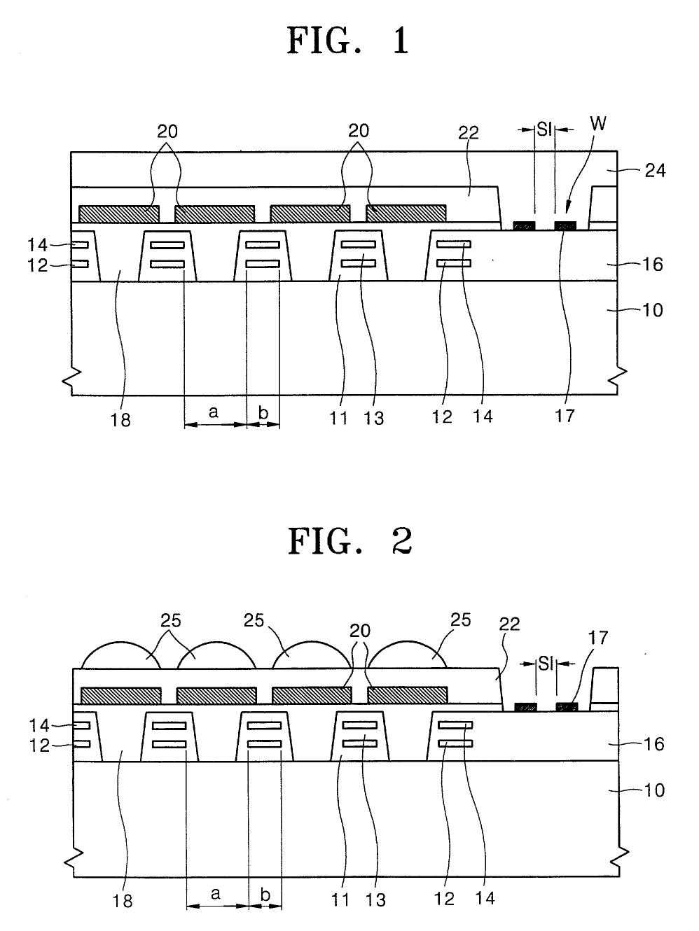

Referring to FIG. 1, a semiconductor substrate 10 is defined as an array region having light receiving portions (a) and charge transmitting portions (b), and a peripheral region which is located outside the array region. Optical diodes (not shown) are formed in th light receiving portions (a) of the semiconductor substrate 10 by a well-known method. Charge transmission electrodes 12 for controlling charge transmission are formed in the charge transmitting portions (b) on both sides of the light receiving portions (a). First insulating films 11 are formed between the charge transmission electrodes 12 and the semiconductor substrate 10 for insulation. Light shielding films 14 are formed so as to cover an array region excluding the light receiving portions (a). The light shielding films 14 prevent light from being incident on the charge transmitting portions (b) and can be formed, for example, over the charge transmission electrodes 12. Second insulating films 13 are formed between the light shielding films 14 and the charge transmission electrodes 12 and insulate the light shielding films 14 from the charge transmission electrodes 12. A protecting film 16 is formed on the resulting structure including semiconductor substrate 10 so as to protect the light shielding films 14. The protecting film 16, the second insulating films 13, and the first insulating films 11 are patterned so as to surround the light shielding films 14 and the charge transmission electrodes 12. Accordingly, each of the light shielding films 14 and each of the charge transmission electrodes 12 are isolated from adjacent light shielding films 14 and charge transmission electrodes 12. Pads 17 are formed on a predetermined portion of the protecting film 16. The pads 17 transmit a signal in the solid state image pick up device to the outside or transmit a signal outside the solid state image pick up device to the inside of the solid imaging device. The pads 17 are formed on the peripheral region, i.e., the outer block of the array region, in which the light receiving portions (a) and the charge transmitting portions (b) are successively arranged. For example, a pair of pads 17 can be arranged to be separated from each other by a predetermined distance. Also, the pads 17 are preferably formed of a metal having an excellent conductive characteristic. Here, a scribe line (sl) is scribed at the midway point between the pads 17 to be sawed later in each die.

Referring to FIG. 1, a first planarizing film 18 is formed on the semiconductor substrate 10, on which the protecting film 16 is formed. The resultant semiconductor substrate 10 has a flat surface due to the formation of the first planarizing film 18. Color filters 20 are formed on a predetermined portion of the first planarizing film 18 by a well-known method. Each of the color filters 20 is formed to correspond to the light receiving portions (a). A second planarizing film 22 is formed in the resultant structure on the semiconductor substrate 10, on which the color filters 20 are formed, to a predetermined thickness. The first and second planarizing films 18 and 22 are preferably formed of a transparent material such as a photoresist material. An opening w is formed by patterning the first and second planarizing films 18 and 22. Accordingly, photosensing device arrays including the charge transmission electrodes 12, the light shielding films 14, the pads 17, the color filters 20, etc. are completed on the semiconductor substrate 10. A material 24 for forming microlenses is formed on the resultant surface of the semiconductor substrate 10. The material 24 for forming the microlenses is preferably a transparent organic material such as the photoresist material. Novolak Resin is used as the material 24 for forming the microlenses in the present embodiment. As shown in FIG. 2, predetermined portions of the material 24 for forming the microlenses are exposed to light so that the microlenses to be formed exist in the light receiving portions (a). The exposed material 24 for forming the microlenses is developed by a developing solution, and then, the exposed portion of the material 24 for forming the microlenses is removed by the developing solution. Accordingly, the unexposed portion of the material 24 for forming the microlenses is left on the light receiving portions (a) such that the remaining material 24 for forming the microlenses becomes a lens pattern (not shown). At that time, the microlens region corresponds to the light receiving portions (a).

In order to improve the transmissivity of the material 24 for forming the microlenses, ultraviolet (UV) rays are irradiated into the lens pattern. At this time, the UV rays decompose photo active compound (PAC), which the material for forming the microlenses has, thus preventing light from being absorbed. Such a method is referred to as a bleaching process. UV rays having a visible wavelength and an energy of between 500 and 2,000 mJ/cm² are generally irradiated. The lens pattern (not shown) is thermally treated at a temperature of 200° C. or less, i.e. thermal energy is supplied to the lens pattern, so that the lense pattern flows. Accordingly, microlenses 25 having a predetermined radius of curvature are formed. The surfaces of the microlenses 25 have a pencil hardness of about 2 since such thermal energy is provided. The microlenses 25 correspond to the color filters 20 and the light receiving portions (a).

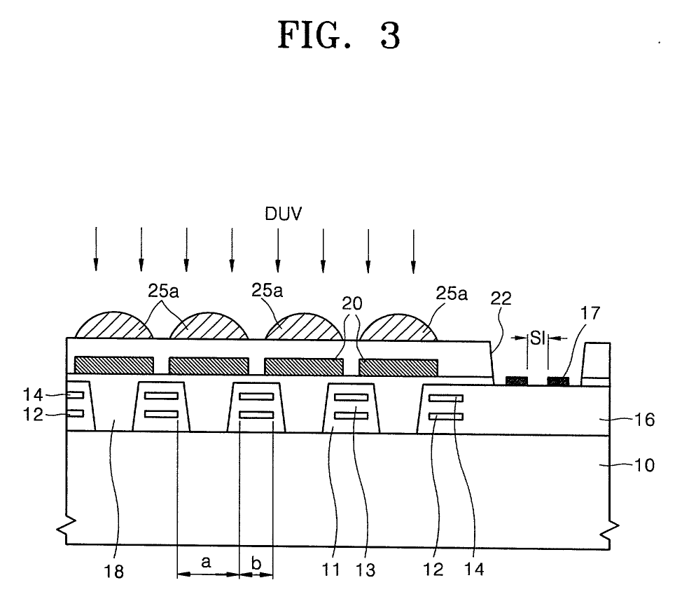

There is much danger that the microlenses 25, whose pencil hardness is about 2, can be lifted or damaged during a subsequent assembling process, such as in the above-mentioned conventional technology. Accordingly, in the present invention, the surfaces of the microlenses 25 are additionally hardened. Namely, as shown in FIG. 3, light, for example, deep UV (DUV) rays, is irradiated into the microlenses 25. The DUV rays have a wavelength of between 200 and 400 nm and are irradiated into the microlenses 25 so that an optical energy of about between 600 and 1,000 mJ/cm² is supplied to the microlenses 25. The film of the microlenses 25a is made denser by irradiating the DUV rays into the microlenses 25a. Furthermore, bonds between C═O and C═N, or between N═N molecules in an organic matter affect the pencil hardness and are cut. Therefore, the pencil hardness increases to about 7-10. Since the microlenses 25a are additionally hardened by irradiating light into the microlenses 25a, a high temperature is not applied to the microlenses 25a. Accordingly, the hardness of the microlenses 25a increases without changing the transmissivity characteristic of the microlenses 25a. Reference numerals 25 and 25a denote microlenses before irradiation of light and hardened microlenses after irradiation of light, respectively.

When the hardness of the microlenses 25 increases, the phenomenon where the microlenses 25 are broken is significantly reduced in the subsequent assembling process. Even though silicon powder is generated when the die is sawed, the microlenses 25 are not studded with the silicon powder (not shown) since the hardness of the microlenses 25 is high.

The present invention is not restricted to the above-mentioned embodiment. For example, in the present embodiment, the DUV rays are used as light for hardening the microlenses. However, any light sources, which can increase the pencil hardness of the microlenses to about 7-10by being irradiated into the microlenses, can be used.

As mentioned above, according to the present invention, the hardness of the surfaces of the microlenses is increased by irradiating the DUV rays into the surfaces of the microlenses after forming the microlenses. Accordingly, a phenomenon where the microlenses are broken during the successive assembling process is reduced and the occurrence of a black spot phenomenon caused by silicon powder is reduced when the die is sawn.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of manufacturing a solid state image pick up device having microlenses, comprising:
forming a plurality of photosensing device arrays on a semiconductor substrate;
forming a plurality of microlenses on the semiconductor substrate on which the photosensing device arrays are formed; and
hardening the surfaces of the microlenses by irradiating light into the microlenses.

2. The method of claim 1, wherein, in irradiating light into the microlenses, light is irradiated into the microlenses until the pencil hardness of the microlenses reaches 7-10.

3. The method of claim 2, wherein the light is deep ultraviolet (DUV) rays.

4. The method of claim 1, wherein, in irradiating light into the microlenses, DUV rays having a bandwidth between 200 and 400 nm are irradiated into the microlenses so that an optical energy of between 600 and 1,000 mJ/cm² is supplied to the microlenses.

5. The method of claim 1, wherein the step of forming a plurality of photosensing device arrays on the semiconductor substrate comprises:
providing a semiconductor substrate, in which a plurality of light receiving regions and a plurality of charge transmitting regions are defined;
forming optical diodes in the respective light receiving regions;
forming charge transmission electrodes in the respective charge transmitting regions;
forming light shielding films so that the light receiving regions are exposed;
isolating the charge transmitting electrodes and the light shielding films from each other by an insulating film so that the charge transmission electrodes are insulated from the light shielding films;
forming pads on predetermined portions of the insulating film; and
forming first and second planarizing films in the resultant surface of the semiconductor substrate on which the pads are formed in order.

6. The method of claim 5, further comprising the step of forming color filters between the first and second planarizing films so as to correspond to the light receiving regions.

7. The method of claim 5, wherein the first and second planarizing films are formed of a transparent organic material.

8. The method of claim 1, wherein the step of forming the plurality of microlenses comprises:
forming a material for forming microlenses on the resultant surface of the semiconductor substrate;
forming a lens pattern by exposing and developing a predetermined portion of the material for forming the microlenses; and
forming microlenses by supplying thermal energy so that the surface of the lens pattern has a radius of curvature.

9. The method of claim 8, wherein the microlenses are formed so as to correspond to the respective light receiving regions.

10. The method of claim 9, wherein the material for forming the microlenses is a transparent organic material.

11. The method of claim 8, further comprising the step of irradiating UV rays between step of forming the lens pattern and step of supplying thermal energy to the lens pattern, in order to improve the transmissivity of the lens pattern.

12. The method of claim 11, wherein the energy of the irradiated UV rays is between 500 and 2,000 mJ/cm².

13. A method of manufacturing a solid state image pick up device having microlenses, comprising:
forming a plurality of photosensing device arrays on a semiconductor substrate;
forming a plurality of microlenses on the semiconductor substrate on which the photosensing device arrays are formed; and
hardening the surfaces of the microlenses by irradiating DUV rays into the microlenses;
wherein the DUV rays are irradiated into the microlenses until the pencil hardness of the microlenses reaches 7-10.

14. The method of claim 13, wherein, in irradiating the DUV rays into the microlenses, DUV rays having a bandwidth between 200 and 400 nm are irradiated into the microlenses so that an optical energy of between 600 and 1,000 mJ/cm² is supplied to the microlenses.

15. The method of claim 14, wherein the step of forming the photosensing device arrays comprises:
providing a semiconductor substrate, in which a plurality of light receiving redundant regions and a plurality of charge transmitting regions are defined;
forming optical diodes in the respective light receiving regions;
forming charge transmission electrodes in the respective charge transmitting regions;
forming light shielding films so that the light receiving regions are exposed;
isolating the charge transmitting electrodes and the light shielding films from each other by an insulating film so that the charge transmission electrodes are insulated from the light shielding films;
forming pads on predetermined portions of the insulating film; and
forming first and second planarizing films in the resultant surface of the semiconductor substrate on which the pads are formed in order.

16. The method of claim 15, further comprising the step of forming color filters between the first and second planarizing films so as to correspond to the light receiving regions.

17. The method of claim 16, wherein the planarizing films are formed of a transparent organic material.

18. The method of claim 13, wherein the step of forming the microlens array comprises:
forming a material for forming microlenses on the resultant surface of the semiconductor substrate;
forming a lens pattern by exposing and developing a predetermined portion of the material for forming the microlenses; and
forming microlenses by supplying thermal energy so that the surface of the lens pattern has a radius of curvature.

19. The method of claim 18, wherein the microlenses are formed so as to correspond to the respective light receiving regions.

20. The method of claim 18, wherein the material for forming the microlenses is a transparent organic material.

21. The method of claim 18, further comprising the step of irradiating UV rays between step of forming the lens pattern and step of supplying thermal energy to the lens pattern, in order to improve the transmissivity of the lens pattern.

22. The method of claim 21, wherein the energy of the irradiated UV rays is between 500 and 2,000 mJ /cm².
